(19) United States
(12) Patent Application Publication
(10) Pub. No.: US 2007/0271082 A1
(43) Pub. Date: Nov. 22, 2007

(54) User configurable device simulator with injection error capability

(76) Inventors: Scott Dominguez, Colorado Springs, CO (US); Mike Bieker, Colorado Springs, CO (US)

Correspondence Address: Pete Scott, Senior Corporate Counsel;LSI Logic Corporation, Legal Department - IP, 1621 Barber Lane, MS D-106, Milpitas, CA, 95035, US

(21) Appl. No.: 11/438,787

(22) Filed: May 22, 2006

(51) Int. Cl. G06F 13/10

(52) U.S. Cl. 703/20

(57) ABSTRACT

A data-processing apparatus, method and program product generally includes a graphical user interface, which is provided to generate a simulation of one or more target devices based one or more user inputs to the graphical user interface. The simulation of the target device(s) can be automatically generated device based on the particular user input(s) to the graphical user interface. A topology of the target device(s) can then be compiled based on the simulation of the target device(s). Such a topology is utilized for testing of the target device(s). The simulation of the device(s) can also be utilized to modify the target device(s) on a per-device basis. A script of errors is also compiled for injection into the target device(s) for testing of the target device(s). The target device can be, for example, an SAS device, an SMP device and/or an SATA device.

### TECHNICAL FIELD

Embodiments are generally related to data-processing methods and systems. Embodiments are also related to Input/Output (I/O) control methods and systems. Embodiments are additionally directed to I/O interface devices and components, such as, for example, Serial Attached SCSI (SAS) devices.

### BACKGROUND OF THE INVENTION

In a conventional data-processing system, such as a computer and/or a computer network, one or more processors may communicate with input/output (I/O) devices over one or more buses. The I/O devices may be coupled to the processors through an I/O interface such as an I/O bridge, which can manage the transfer of information between a peripheral bus connected to the I/O devices and a shared bus connected to the processors. Additionally, the I/O interface may manage the transfer of information between system memory and the I/O devices or the system memory and the processors.

An I/O interface can also be utilized to transfer information between I/O devices and main storage components of a host processor. An I/O channel, for example, may connect the host directly to a mass storage device (e.g., disk or tape drive). In the case of a mainframe host processor, the channel is usually coupled to one or more device controllers. Each device controller can in turn be connected to a plurality of mass storage devices.

Small Computer Systems Interface (“SCSI”) is a set of American National Standards Institute (“ANSI”) standard electronic interface specification that allows, for example, computers to communicate with peripheral hardware. Common SCSI compatible peripheral devices may include: disk drives, tape drives, Compact Disc-Read Only Memory (“CD-ROM”) drives, printers and scanners. SCSI as originally created included both a command/response data structure specification and an interface and protocol standard for a parallel bus structure for attachment of devices. SCSI has evolved from exclusively parallel interfaces to include both parallel and serial interfaces. “SCSI” is now generally understood as referring either to the communication transport media (parallel bus structures and various serial transports) or to a plurality of primary commands common to most devices and command sets to meet the needs of specific device types as well as a variety of interface standards and protocols.

The collection of primary commands and other command sets may be used with SCSI parallel interfaces as well as with serial interfaces. The serial interface transport media standards that support SCSI command processing include: Fibre Channel, Serial Bus Protocol (used with the Institute of Electrical and Electronics Engineers 1394 FireWire physical protocol; “IEEE 1394”) and the Serial Storage Protocol (SSP).

SCSI interface transports and commands are also used to interconnect networks of storage devices with processing devices. For example, serial SCSI transport media and protocols such as Serial Attached SCSI (“SAS”) and Serial Advanced Technology Attachment (“SATA”) may be used in such networks. These applications are often referred to as storage networks. Those skilled in the art are familiar with SAS and SATA standards as well as other SCSI related specifications and standards. Information about such interfaces and commands is generally obtainable at the website http://www.t10.org.

Such SCSI storage networks are often used in large storage systems having a plurality of disk drives to store data for organizations and/or businesses. The network architecture allows storage devices to be physically dispersed in an enterprise while continuing to directly support SCSI commands directly. This architecture allows for distribution of the storage components in an enterprise without the need for added overhead in converting storage requests from SCSI commands into other network commands and then back into lower level SCSI storage related commands.

A SAS network typically comprises one or more SAS initiators coupled to one or more SAS targets via one or more SAS expander devices. In general, as is common in all SCSI communications, SAS initiators initiate communications with SAS targets. The expander devices expands the number of ports of a SAS network domain used to interconnect SAS initiators and SAS/SATA targets (collectively referred to as SAS devices)

One of the problems with current SAS devices is that there is a continuing need to test SAS devices in a complete domain aside from testing standard operations. A test is needed to stress the error handling capabilities of the expander itself. It is difficult to test the initiator's link error handling capabilities in an SAS domain when there are expanders present. Because SAS is a relatively new protocol, there are few tests which stress these characteristics.

### BRIEF SUMMARY

The following summary of the invention is provided to facilitate an understanding of some of the innovative features unique to the present invention and is not intended to be a full description. A full appreciation of the various aspects of the invention can be gained by taking the entire specification, claims, drawings and abstract as a whole.

It is therefore one aspect of the present invention to provide for improved data-processing methods and systems.

It is another aspect of the present invention to provide for a method and apparatus for injecting errors into SAS domains through simulated SAS devices and SAS expanders, for testing purposes.

The e above and other aspects of the invention can be achieved as will now be briefly described. A data-processing apparatus, method and program product thereof is disclosed, which generally includes a graphical user interface (“GUI”). The GUI is provided to generate a simulation of one or more target devices based one or more user inputs to the graphical user interface. A simulation of the target device(s) can be automatically generated based on the particular user input(s) to the graphical user interface. A functional topology of the target device(s) can then be compiled based on the topology of the target device(s) within the GUI. As such, a functional topology can then be utilized for testing of both non-simulated target device(s) and/or Host controllers in a real-world environment. The GUI, simulating the target device(s), can also be utilized to modify the characteristics of target device(s) on a per-device basis. A script of errors can also be compiled for injection into the topology by the target device(s) for testing of the target device(s) and a host controller. The target device can be, for example, an SAS device, an SMP device and/or an SATA device.

### BRIEF DESCRIPTION OF THE DRAWINGS

The accompanying figures, in which like reference numerals refer to identical or functionally similar elements throughout the separate views and which are incorporated in and form part of the specification, further illustrate embodiments of the present invention.

FIG. 1 illustrates a block diagram of a system in which a preferred embodiment of the present invention can be implemented;

FIG. 2 illustrates an SAS expander having an integral custom expander circuit die embedded within, which can be adapted for use in accordance with an embodiment;

FIG. 3 illustrates a high-level flow chart of operations depicting logical operational steps that can be implemented in accordance with a preferred embodiment;

FIG. 4 illustrates a screen shot of a graphical user interface window, which can be implemented in accordance with a preferred embodiment;

FIG. 5 illustrates a screen shot of the graphical user interface window illustrated in FIG. 4 with “file” options depicted, in accordance with a preferred embodiment;

FIG. 6 illustrates a screen shot of the graphical user interface window illustrated in FIGS. 5-6 with “setting” options depicted, in accordance with a preferred embodiment;

FIG. 7 illustrates a screen shot of a graphical user interface window that allows a user to override the “Manufacturer” section of a default SAS address used for all simulated devices, in accordance with a preferred embodiment;

FIG. 8 illustrates a screen shot of a graphical user interface window that allows a user to modify the current default virtual drive size, in accordance with a preferred embodiment;

FIG. 9 illustrates a screen shot of a graphical user interface drop down list that allows a user to modify a performance throttle, in accordance with a preferred embodiment;

FIG. 10 illustrates a screen shot of a graphical user interface window that allows a user to access “help” options, in accordance with a preferred embodiment;

FIGS. 11-15 illustrate screen shots of a graphical user interface window that permits a user to create a topology, in accordance with a preferred embodiment;

FIG. 16 illustrates a screen shot of a graphical user interface option list that permits a user to modify device configurations, in accordance with a preferred embodiment;

FIGS. 17-19 illustrates screen shots of a graphical user interface that permits a user to change an SAS device into an SMP device (expander), in accordance with a preferred embodiment;

FIG. 20 illustrates a screen shot of a graphical user interface option list that permits a user to modify an SMP Expander device's configuration, in accordance with a preferred embodiment;

FIG. 21 illustrates a screen shot of a graphical user interface tab for editing inquiry and modifying data for an SATA device, in accordance with a preferred embodiment;

FIG. 22 illustrates a screen shot of a graphical user interface window with a trigger selection tab, in accordance with a preferred embodiment;

FIG. 23 illustrates a screen shot of a graphical user interface trigger selection drop down list, in accordance with a preferred embodiment;

FIG. 24 illustrates a screen shot of a graphical user interface trigger selection window, in accordance with a preferred embodiment;

FIG. 25 illustrates a diagram of an LBA-based trigger example, in accordance with a preferred embodiment;

FIGS. 26-27 illustrate screen shots of respective graphical user interface event selection windows 1027 and 1028 in accordance with a preferred embodiment.

FIG. 28 illustrates a screen shot of a graphical user interface event selection window in accordance with a preferred embodiment;

FIG. 29 illustrates a screen shot of a graphical user interface event selection window in accordance with a preferred embodiment;

FIG. 30 illustrates a screen shot of a graphical user interface window with a view of a possible response value, in accordance with a preferred embodiment;

FIG. 31 illustrates a screen shot of a graphical user interface window with an interface trigger tab in accordance with a preferred embodiment;

FIG. 32 illustrates a screen shot of a graphical user interface stopped menu, in accordance with a preferred embodiment;

FIG. 33 illustrates a screen shot of a graphical user interface running menu, in accordance with a preferred embodiment; and

FIG. 34 illustrates a screen shot of a graphical user interface activity tab, in accordance with a preferred embodiment.

### DETAILED DESCRIPTION OF THE INVENTION

The particular values and configurations discussed in these non-limiting examples can be varied and are cited merely to illustrate embodiments of the present invention and are not intended to limit the scope of the invention.

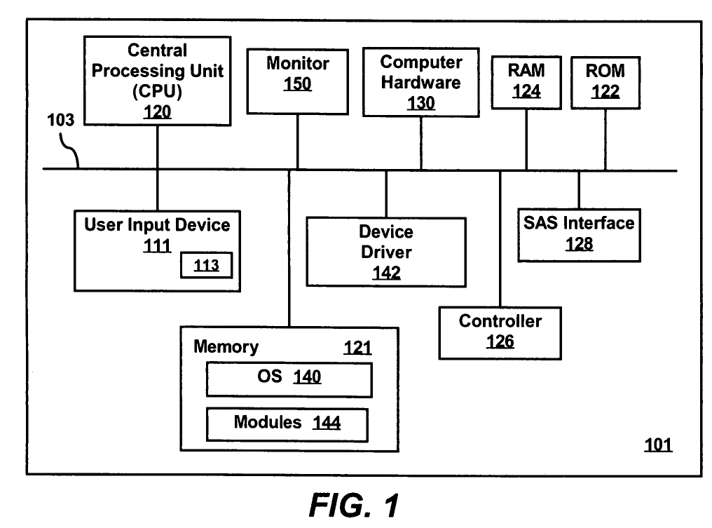

For a further understanding of the present invention, reference is made to FIG. 1, which depicts a data-processing apparatus 101 in which an embodiment can be implemented. Data processing apparatus 101 of FIG. 1 generally includes a user input device 111, a central processing unit 120, computer hardware 130, and a monitor 150. The user input device 111 can be coupled to the central processing unit 120 wherein the central processing unit 120 is coupled to the computer hardware 130 and the operating system 140. User input device 111 can be implemented, for example, as a computer keyboard, a computer mouse, and so forth.

The central processing unit 120 can be connected to a bus 103, which in turn can be connected to other system components, such as, for example, memory 121, Random Access Memory (RAM) 124, Read Only Memory (ROM) 124, a controller 126, and an SAS interface 128. Note that controller 126 can be implemented as one or more controller types. For example, controller 126 can be configured as Small Computer Systems Interface (SCSI) controller and/or other types of controllers. It can be appreciated, however, that the use of an SCSI controller is described herein for illustrative purposes only and is not considered a limiting feature of the disclosed embodiments.

System bus 103 can also be connected to other components of data processing apparatus 101, such as, for example, monitor 150, device driver 142 and user input device 111. The SAS interface 128 is generally associated with operating system 140. Note that device driver 142 can be implemented as an SCSI device driver, depending upon design considerations. Memory 121, which is coupled to bus 103, can communicate with the central processing unit 120 via bus 103. Operating system (OS) 140 can be stored within memory 121 and processed via CPU 120. A software module 144 can also be stored within memory 121. Note the term “module” is defined in greater detail herein.

The device driver 142 can be implemented as a software or instruction module stored in a memory, such as memory 121, which can be utilized to communicate with the controller 126. Thus, although device driver 142 is illustrated in FIG. 1 as a separate “block,” it can be appreciated that device driver 142 can be implemented in the context of a module storable in a computer memory. Device driver 142 generally functions as a module or group of modules that communicates between OS 140 and the controllers described herein. Similarly, SAS interface 128, which is also depicted in FIG. 1 as constituting a separate “block”, can form a part of OS 140 to allow for direct communication such as sending messages to and from device driver 142.

The operating system 140 is the master control program that runs the computer. It sets the standards for all application programs that run in the computer. Operating system 140 can be implemented as the software that controls the allocation and usage of hardware resources, such as memory 121, central processing unit 120, disk space, and other peripheral devices, such as monitor 150, user input device 111 and computer hardware 130. Examples of operating systems, which may be utilized to implement operating system 140 of apparatus 101, include Windows, Mac OS, UNIX and Linux.

Bus 103 can be implemented as a plurality of conducting hardware lines for data transfer among the various system components to which bus 103 is attached. Bus 103 functions as a shared resource that connects varying portions of data-processing apparatus 101, including the CPU 120 (i.e., a microprocessor), controllers, memory and input/output ports and so forth and enabling the transfer of information. Bus 103 can be configured into particular bus components for carrying particular types of information. For example, bus 103 can be implemented to include a group of conducting hardware lines for carrying memory addresses or memory locations where data items can be found, while another group of conducting hardware lines can be dedicated to carrying control signals, and the like.

The user input device 111 can include a plurality of device descriptor files 113. The device descriptor files 113 contain information related to the user input device, e.g. what type of device it is, who made the device, etc. The device descriptor files 113 can also contain user-defined fields called report descriptors. Report descriptors are strings of information that the operating system 140 can read. Report descriptors can be implemented, for example, as for passing useful information about the user input device 111 to the operating system 140 and/or a device driver 142. Such report descriptors are unique for each type of user input device.

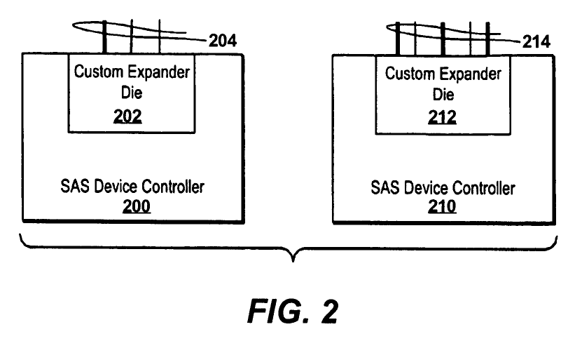

FIG. 2 illustrates an SAS expander 200 having an integral custom expander circuit die 202 embedded within, which can be adapted for use in accordance with an embodiment. Custom expander circuit die 202 is designed by an appropriate engineer to provide, for example, three ports adapted for coupling to SAS devices outside SAS expander 200. Ports 204 are exemplified by two thinner lines representing standard ports and one thicker line representing a wide port configuration as generally known in the SAS specifications. SAS device controller 210 is a similar SAS controller including a custom expander circuit die 212 providing external ports 214—two standard ports represented by thinner lines and three wide ports represented by thicker lines.

The SAS expander 200 depicted in FIG. 2 can be implemented in accordance with the system 100 depicted in FIG. 1. That is, system 100 can be modified to function in accordance with the SAS expander 200 depicted in FIG. 1. Note that the controller 126 depicted in FIG. 1 can be implemented as the SAS device controller 210 depicted in FIG. 2. Similarly, the SAS expander 200 can be implemented in place of or in association with the SAS interface 128 depicted in FIG. 1.

Note that embodiments of the present invention can be implemented in the context of modules. Such modules may constitute hardware modules, such as, for example, electronic components of a computer system. Such modules may also constitute software modules. In the computer programming arts, a software module can be typically implemented as a collection of routines and data structures that performs particular tasks or implements a particular abstract data type.

Software modules generally are composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. The term module, as utilized herein can therefore refer to software modules or implementations thereof. Such modules can be utilized separately or together to form a program product that can be implemented through signal-bearing media, including transmission media and recordable media. An example of such a module is module 144 stored within memory 121, as depicted in FIG. 1. Note that the OS 140 depicted in FIG. 1 can also be implemented as a software module or group of modules, depending upon design considerations.

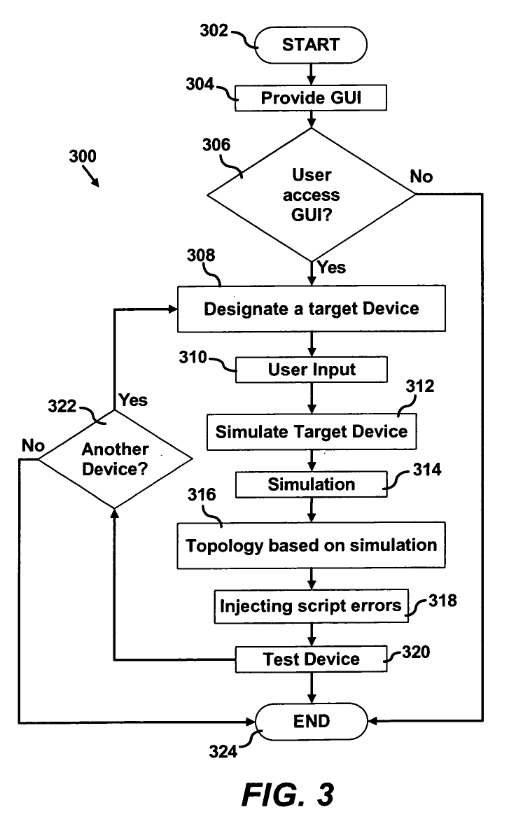

The methodology depicted in FIG. 3, for example, can be implemented as one or more such modules (e.g., see modules 144 in FIG. 1). Such modules can be referred to also as “instruction modules” and may be stored within a memory of a data-processing system such as memory 121 of FIG. 1. Modules 144 depicted in FIG. 1 represent such instruction modules. Such instruction modules may be implemented in the context of a resulting program product (i.e., program “code”). Note that the term module and code can be utilized interchangeably herein to refer to the same device or media.

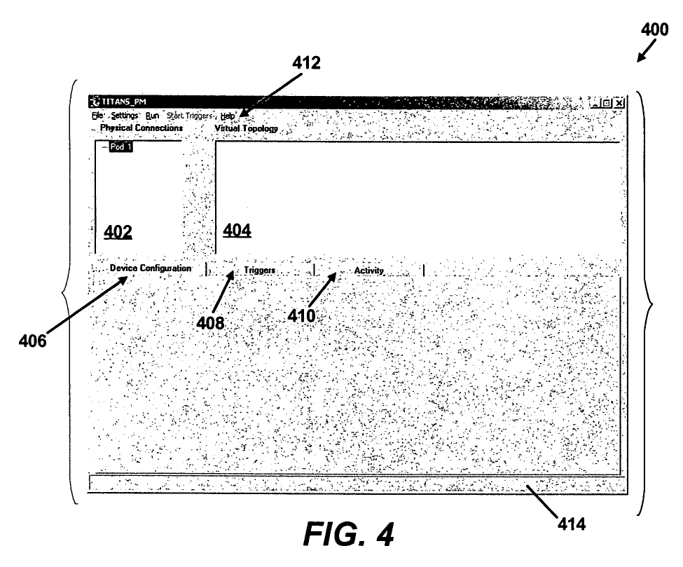

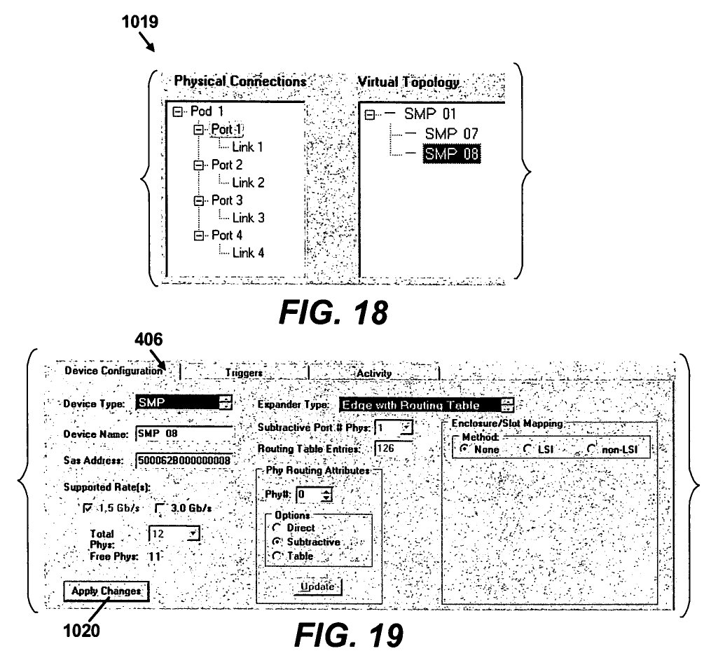

FIG. 3 illustrates a high-level flow chart of operations depicting logical operational steps of a method 300 that can be implemented in accordance with a preferred embodiment. The process or method 300 can be initiated as indicated at block 302. Thereafter, as indicated at block 304, a graphical user interface (GUI) can be provided for a user. Note that an example of such as GUI is depicted and described in greater detail herein with respect to FIGS. 4-36. As depicted next at block 306, a test can be performed to determine whether or not the user has accessed the GUI. If not, then the process simply terminates as indicated at block 324. If the answer is “yes” then as indicated at block 308, a target device can be designated.

Thereafter, as illustrated at block 310, a user can provide input via the GUI. Next, as indicated at block 312, a target device can be simulated in response to the input to the GUI as described previously with respect to block 310. A simulation can then be run as indicated at block 314 and thereafter as described at block 316 a topology associated with the target device can be configured based on the simulation. Next, as indicated at block 318, script errors can be injected into-the target device for testing purposes. The target device is actually tested as illustrated thereafter at block 320. A test can then be performed, as indicated at block 322 to determine if another target device is to be tested. If so, then the process begins again as indicated at block 308. If not, then the process simply terminates as described at block 324. In general, the tool described herein initially creates the simulated topology. Scripts can be loaded to various devices, and then finally the simulation is started. The target devices do not actually do anything until they receive input from a Host SAS Controller or from an Expander attached to a Host SAS Controller. The target devices can automatically respond to the Host I/O requests. When the user actives the scripts via ‘Start Triggers’, errors can then be finally injected. The user has the opportunity to ‘Stop Triggers’ without stopping the target devices from responding to the Host.

FIG. 4 illustrates a screen shot of a graphical user interface window 400, which can be implemented in accordance with a preferred embodiment. Window 400 generally includes a target operation window 402, a Virtual Topology section, window 404, a Device Configuration tab 406, a Trigger tab 408, and an Activity tab 410. A menu bar 412 is also included in window 400. A mouse or other pointing device can be utilized by a user to access any of the available options of the menu bar 412 such as, for example, File, Settings, Run, Start Triggers, and Help options. Window 400 also includes an area that functions as a status bar 414.

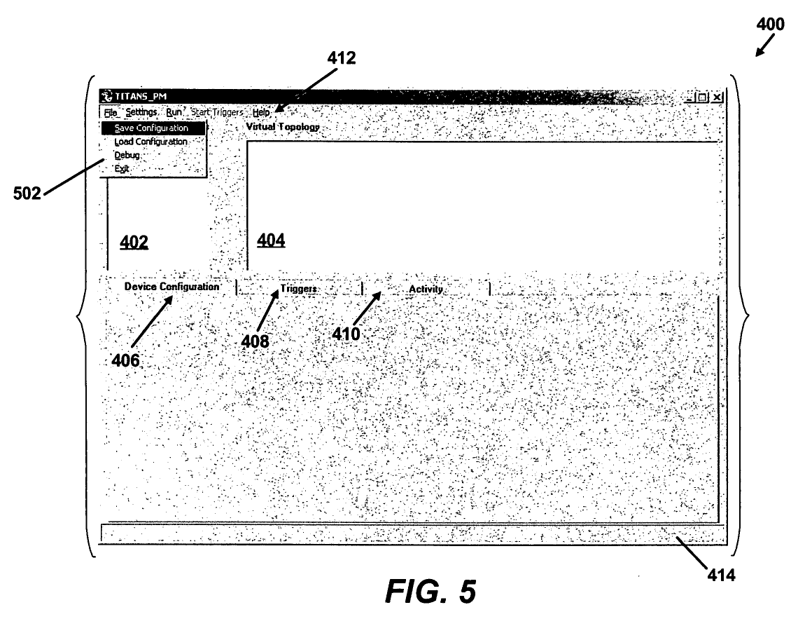

FIG. 5 illustrates a screen shot of the graphical user interface window 400 illustrated in FIG. 4 with “file” options 502 depicted, in accordance with a preferred embodiment. The “file” options 502 can be selected from the menu bar 412. In general, under the ‘File’ options, the options available are: Load Configuration, Save Configuration, Debug and Exit. Note that in FIGS. 4-5, identical or similar parts or elements are generally indicated by identical reference numerals. The Save Configuration option saves the current settings for Target Topology and Target Event Scripts. The user will have the opportunity to provide a filename and select a folder for the Saved Configuration. The Load Configuration option will allow the user to select and load a predefined Target Topology & Trigger setup. The Debug option will create a new tab in the Device Information Window. Debug Tab allows developers to see messages related to how an I/O is processed and is primarily intended for developer use. The Exit option will exit the program. The user should STOP the program prior to exiting if the application is currently in RUN mode.

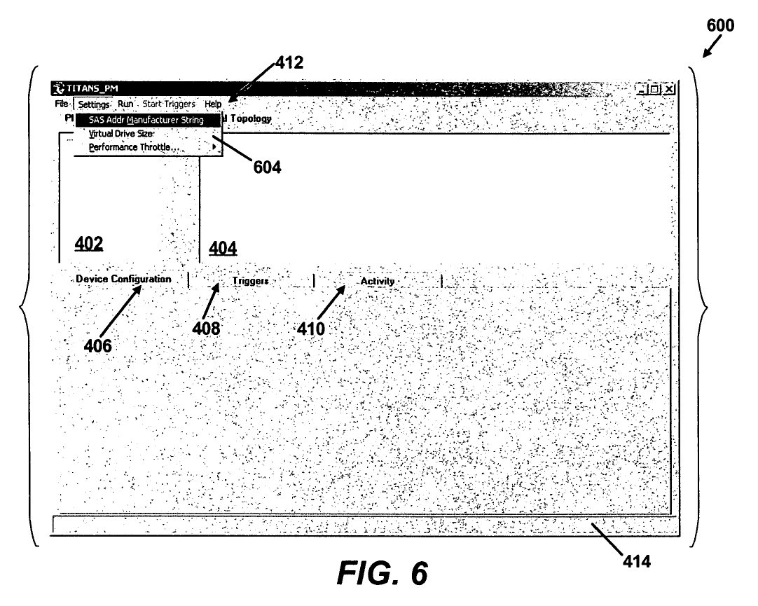

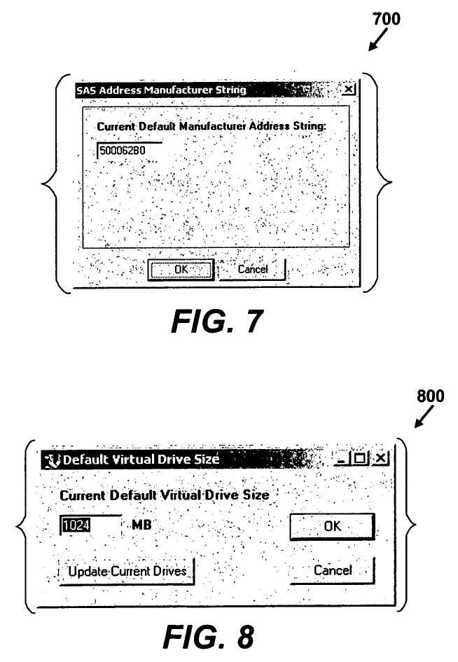

FIG. 6 illustrates a screen shot of the graphical user interface window illustrated in FIGS. 5-6 with “setting” options 604 depicted, in accordance with a preferred embodiment. A user accesses the menu bar 412 in order select from a drop down list provided by the setting options 604. Under the “setting” options 604, the user is generally provided with ‘SAS Addr Manufacturer String’, ‘Virtual Drive Size’, and ‘Performance Throttle’. The ‘SAS Addr Manufacturer String’ option allows the user to override the ‘Manufacturer’ section of the default SAS Address used for all simulated devices. Note that an SAS address is generally defined according to one or more of the SAS specifications, such as SAS specification, ANSI/INCITS 376-2003. The user is provided with the graphical user interface prompt 700, which is shown in FIG. 7.

FIG. 7 illustrates a screen shot of a graphical user interface window or prompt 700 that allows a user to override the ‘Manufacturer’ section of a default SAS address used for all simulated devices, in accordance with a preferred embodiment. FIG. 8 illustrates a screen shot of a graphical user interface window or prompt 800 that allows a user to modify the current default virtual drive size, in accordance with a preferred embodiment. The Virtual Drive Size option 800 allows the user to change the default size (in MBs) for all future HDDs defined in this simulated topology. This option will also modify the current value of all HDDs that are currently loaded in the topology, on all links. The user must size the ‘default size’ so that the total allocated capacity of all the HDDs in the topology is less than the capacity of the physical HDD that TITAMS_PM is mapped to. Note that each simulated SAS/SATA target is mapped to a small area of a real, physical HDD. This is so that as the Host Controller communicates with the simulated targets, it can Read back exactly what it wrote, thus truly simulating real HDDs.)

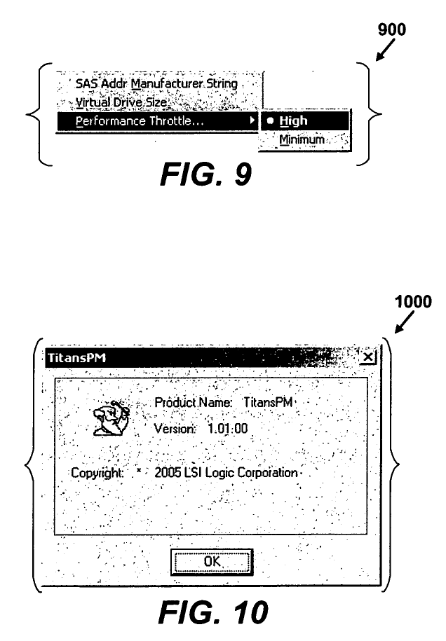

FIG. 9 illustrates a screen shot of a graphical user interface drop down list 900 that allows a user to modify a performance throttle, in accordance with a preferred embodiment. The Performance Throttle option provided via the GUI drop down list 900 allows the user to modify the PacketMaker performance by limiting the number of consecutive packets sent per connection. The default value is set to High. When set to MINIMUM, the number of packets sent to the Host is set the absolute minimum of 2 frames per connection. This option is only required on systems that have problems handling large numbers of data frames. Host systems that have this sort of issue are known to issue CREDIT_BLOCKED or OPEN_REJECT (RETRY) primitives frequently. This subsequently causes error recovery to be attempted by the PacketMaker which generally results in TASK MANAGEMENT requests by the Host to Abort the I/O. Unexpected Task Management requests can be very difficult for the PacketMaker to recover from in any sort of a timely manner and almost always result in the Host failing one or more of the simulated HDDs.

Note that the PacketMaker is a product of the Finisar Corporation of Sunnyvale, Calif. and can be adapted for use in accordance with an embodiment. It can be appreciated, of course, that other types of devices and/or systems may be utilized in place of the PacketMaker apparatus, depending upon design considerations. The PacketMaker product is discussed herein for general illustrative purposes only and is not considered a limiting feature of the present invention.

FIG. 10 illustrates a screen shot of a graphical user interface window 1000 that allows a user to access “help” options, in accordance with a preferred embodiment. The HELP option provided by window 1000 generally displays for the user ‘About’ information. For example, in the illustration of FIG. 10, the TITANS_PM version number and copyright notice can be found. Note that the software package implementing the GUI illustrated in FIGS. 4-36 can be referred to as “TITANS_PM” in some embodiments.

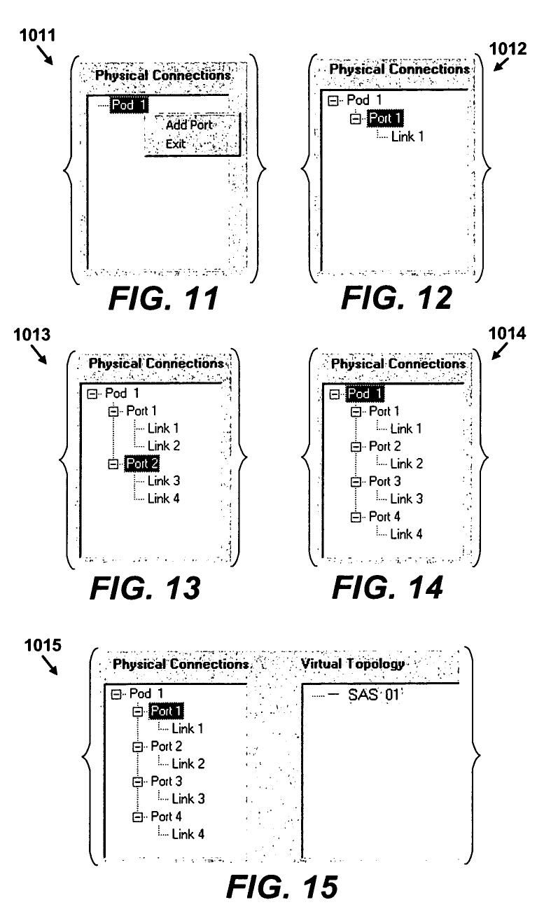

FIGS. 11-15 illustrate screen shots of graphical user interface windows 1011, 1012, 1013, 1014, 1015 that permits a user to create a topology, in accordance with a preferred embodiment. In order to use TITANS_PM the user must first create a topology. The first step in creating a topology is to select the Pod (which is another term for the PacketMaker) and right-click on it. The two available options are: ‘Add Port’ and ‘Exit’ as indicated by window 1011 in FIG. 11. After selecting ‘Add Port’ the display appears as depicted in window 1012 of FIG. 12. This represents the concept of a Port on the PacketMaker Pod. A Port, in this application, can represent one or more physical links (Phys) on the PacketMaker which translates into a narrow port (in the above case). At this point there are three options available to the user. The first is to have a topology which consists of a single Port/Link on the PacketMaker. The second is to add one or more links to this Port, which is the equivalent of simulating a Wide port device. The third is to add additional Ports, which may be made up of one or more Links.

The maximum number of Ports is 4 (one link per Port) and the minimum is a single Port (1-4 links per Port). The topologies are not limited based on the number of Ports or the number of Links per Port. An example of a topology with 2 Ports with 2 Links each is depicted in window 1013 of FIG. 13. The standard topology will consist of 4 Ports each with a single PacketMaker Link as illustrated by window 1014 of FIG. 14. As each Port is created (and assigned Links) the program automatically creates and assigns a default SAS Device to the Port. In order to see the attached device you need to select the Port in the ‘Physical Connections’ window. The ‘Virtual Topology’ window can display the topology assigned to the Port as indicated by window 1015 of FIG. 15.

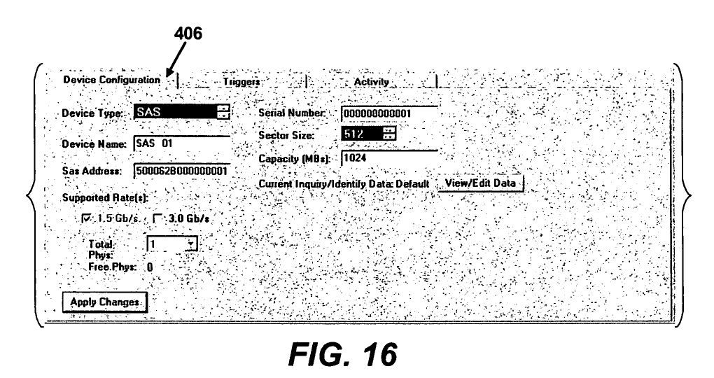

FIG. 16 illustrates a screen shot of a graphical user interface option or tab 406 that permits a user to modify device configurations, in accordance with a preferred embodiment. Note again that throughout the drawings illustrated herein, identical or similar parts are generally indicated by identical reference numerals. The ‘Virtual Topology’ view only displays the topology associated with the currently selected Port. Each Port can have a unique topology. Each topology can have any mix of Expanders, SAS Devices and SATA Devices. It, as the default shows, can also have a single direct attached SAS Device. Note that the ‘Virtual Topology’ view will not prevent the user from creating a direct attach SATA device. Once a SMP, SAS or SATA device has been selected (highlighted) in the ‘Virtual Topology’ window the ‘Device Configuration’ tab 406 can display the information related to the device (i.e., the SAS Device information shown in FIG. 16). The information will be described in a later section.

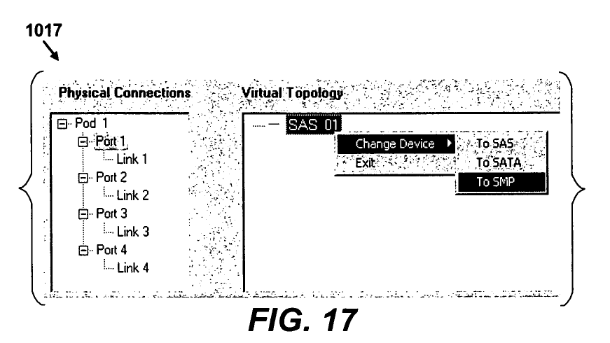

FIGS. 17-19 illustrate respectively screen shots of graphical user interfaces 1017, 1019, and 1020 that permit a user to change an SAS device into an SMP device (expander), in accordance with a preferred embodiment. In order to have topologies greater than a single direct attach SAS Device we need to change the SAS Device into a SMP Device (Expander). The user has two methods to change a device. The first method is to right-click on the SAS Device. As indicated in window or interface 1017 of FIG. 17. Then, via the drop-down menu, the ‘Change Device’ to ‘To SMP’ option can be selected. The second option is to use the ‘Device Configuration’ tab 406 depicted in FIG. 19 and use the ‘Device Type’ box to change the device to SMP. Note that the field can be changed, but the user should hit the ‘Apply Changes’ button 1020 depicted in FIG. 19, in order for the change to actually occur.

Once the device has been changed then additional devices can be added to the expander, including additional expanders. Currently a SASx12 expander is simulated, although a SASx28 or SASx36 might be added future releases. Options such as additional /changing/removing devices are available via a right-click on an appropriate device. Only the appropriate options will appear. For example, if the user right-clicks on ‘SMP 01’ then only ‘Change Device’, ‘Add Device’ and ‘Exit’ will appear since there must always be a top level device (it cannot be removed).

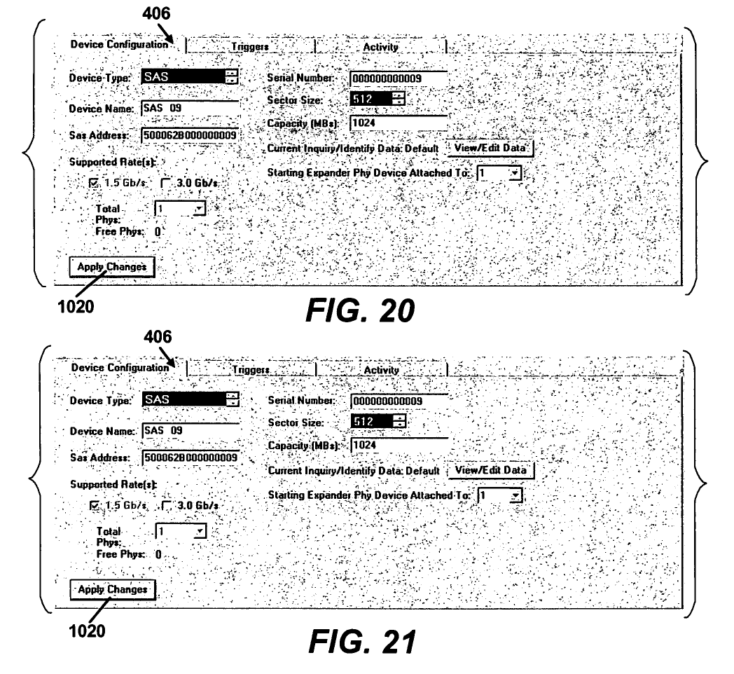

There is currently a limitation of 2 SMP Devices attached to another SMP device although the software modules will not prevent it. Each new SMP Device will be automatically attached to a different Table quad on the higher level SMP Device. In this example, SMP_01 will have SMP_07 on Phy-4 and SMP-08 on Phy8. This avoids users accidentally attaching expanders to the wrong table of the Expander. Refer to window 1019 of FIG. 20 for an example of this process.

FIG. 20 illustrates a screen shot of a graphical user interface option 406 list that permits a user to modify device configurations, in accordance with a preferred embodiment. Once a SMP Device has been selected in the ‘Virtual Topology’ window the ‘Device Configuration’ Tab 406 will change to appear with default information as indicated in FIG. 21. Note that not all fields are available for editing, fields such as: Total Phys, Expander Type, Subtractive Port # Phys, and Routing Table Entries cannot be modified.

With tab 406 the user can modify the Device Type to change the device to a SAS or SATA device, modify the Device Name—which is the loaded into the Inquiry response for SAS and SATA devices or into the Report Manufacturer Information response for SMP devices. With tab 406, the user can also modify the SAS Address, which is reported to the Host (no testing is done to prevent the same SAS Address from appearing two or more times in the same topology). Additionally, with tab 406, the user can change routing attributes for each Phy of the device (by default Phys 0-3 are subtractive routing, Phys 4-11 are table routing), and enable one of two possible methods for Enclosure Slot Mapping.

A Supported Rates—3.0 Gb/s checkbox is available but does not override the fact that the current PacketMaker can only operate at 1.5 Gb/s and therefore has no effect. By default, every SMP Device is attached via its Phy 0 to the prior device (or Host) in the hierarchy. Additionally a Free Phys display is provided, which indicates the number of Phys remaining on the SMP device that are available for use. Since the SMP device must be attached to something, it will always start off with one free Phy less than the total number of phys on the device. In most cases it is best to hit the ‘Apply Changes’ button in order save the changes made in the window. Values associated with ‘Phy Routing Attributes’ require the user to hit the Update button in order to take effect. ‘Enclosure/Slot Mapping’ changes will update immediately so there is no way to restore the default values other then changing or removing the device.

FIG. 21 illustrates a screen shot of a graphical user interface tab 406 for editing inquiry and modifying data for an SATA device, in accordance with a preferred embodiment. Once a SATA Device has been selected in the ‘Virtual Topology’ window the ‘Device Configuration’ Tab will change to appear with default information. Many of the fields on the left-hand side of the window are the same as those available in the SMP Device. Fields such as Serial Number, Capacity (MBs), Current Inquiry/ldentify Data, and Starting Expander Phy Device Attached To are available for editing. The Sector Size scroll box is currently set to 512, but may at some future date have additional sizes

In this tab the user can modify the Device Type to change the device to a SMP or SAS device; modify the Device Name—which is the loaded into the Inquiry response; modify the SAS Address—which is reported to the Host (no testing is done to prevent the same SAS Address from appearing two or more times in the same topology); and modify the Serial Number—as reported during a special Inquiry/EVPD request. The Serial Number should be unique unless the user wishes to simulate a two port device. The user can also use this tab to modify the capacity value reported in a READ CAPACITY command; modify the default Identify data. It is available for editing via the ‘View/Edit Data’ button (see above). The data is displayed as decimal values; and modify which Phy on the attached Expander that attached to. The program will prevent the user from selecting a Phy that is already in use. In most cases it is best to hit the ‘Apply Changes’ button 1020 in order save the changes made in the window.

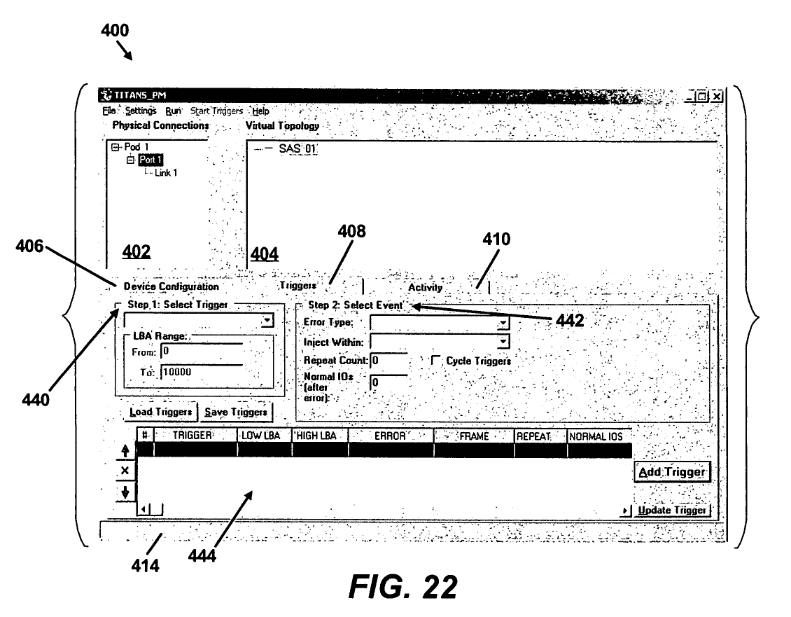

FIG. 22 illustrates a screen shot of a graphical user interface window 400 with a trigger selection tab 408, in accordance with a preferred embodiment. The SAS Triggered Event Scripts Form can appear similar to the display shown in window 400. The form can be broken into three sections: Select Trigger window 440, Select Event 442 and the Event List window 444. This form allows a user to create unique test scenarios for each SAS Device in the topology (the SAS Device highlighted in the ‘Virtual Topology’ window). A user can create a script for each SAS Device in the topology. The basic idea is that a user can have the simulated device wait for the specified Trigger and then respond with the selected Event. If the Trigger is not received then the simulated device will still function properly without inducing any errors—it continues to run successfully waiting for the Trigger to be received. The user can add up to 30 triggers per device.

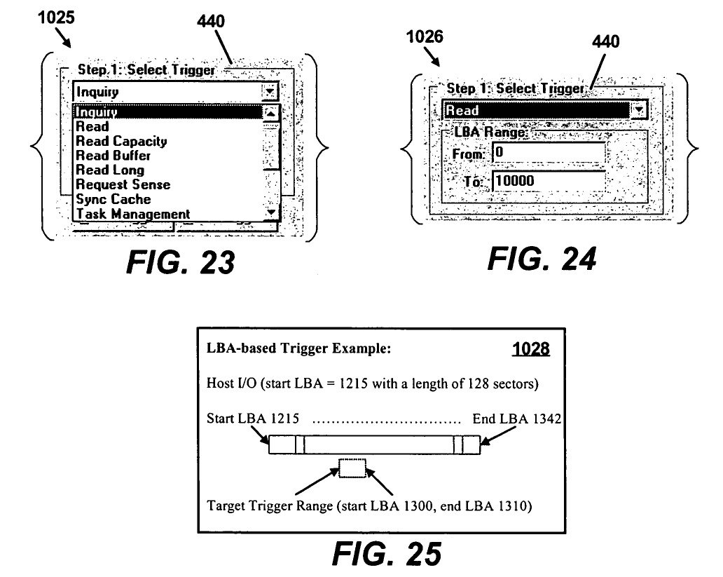

FIG. 23 illustrates a screen shot of a graphical user interface trigger selection drop down list 1025, in accordance with a preferred embodiment. The user must select a device from the ‘Virtual Topology’ list. A unique scenario can be assigned to each simulated Device and once the ‘Start Triggers’ button on the menu bar is clicked all triggers for all devices will be active. The user has the ability to enable/disable Triggered Events on-the-fly. Triggers consist of a variety of SCSI commands that the target may receive.

FIG. 24 illustrates a screen shot of a graphical user interface trigger selection window 1026, in accordance with a preferred embodiment. If the Command requires a LBA then the user may specify the starting and ending range (LBA values) that the Trigger can occur over. If the values are identical then the trigger is based on a single LBA. The Trigger LBA range is such that if any portion of a Host I/O is included or overlaps the trigger LBA range then the trigger is activated. The Trigger LBA Range field can only be entered when the user selects a LBA-based Trigger, otherwise the LBA range fields remain grayed out and inaccessible.

FIG. 25 illustrates a diagram of an LBA-based trigger example 1028 in accordance with a preferred embodiment. In this example, the trigger is activated because the Host I/O overlaps the Trigger address range. The selected Event would then occur. Note: if the Event was to produce a Check Condition Status the subsequent Request Sense information would contain the first LBA that produced the Trigger=>LBA 1300. The LBA is located in the Information Bytes (bytes 3-6) of the Request Sense response. The Valid bit (byte 0, bit 7) is used to indicate that the Information Bytes are valid.

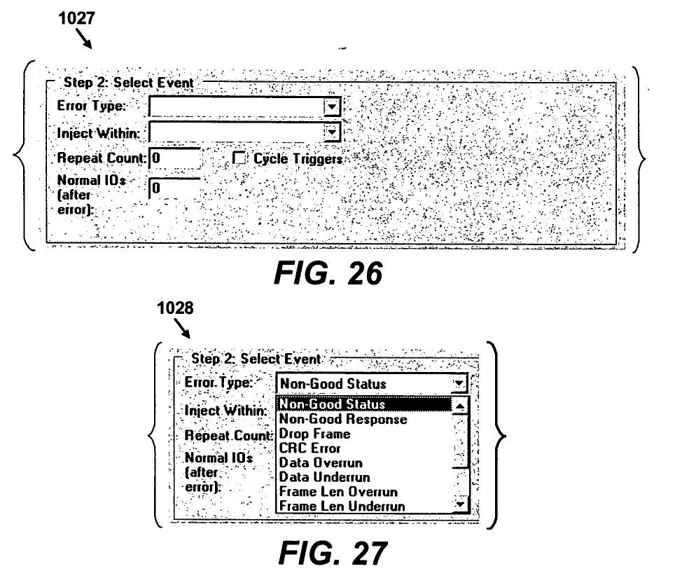

FIGS. 26-27 illustrate screen shots of respective graphical user interface event selection windows 1027 and 1028 in accordance with a preferred embodiment. The ‘Select Event’ form of window 1027 allows the user to select which error to respond with for the Trigger. It also provides the user with a number of operational settings that need to be carefully thought out in order to get the desired ‘error injection’ affect. This is because the user controls the error injection flow such as setting the number of tims the Event will occur before going on the next Trigger (the trigger must occur in order for the event to execute).

ERROR INJECTION: The Error Type list box provides a list of the possible errors to produce. This list box is only filled after a Trigger has been selected since only certain Errors are valid for certain Triggers. Once an error type has been selected the Inject Within list box is filled with the appropriate set of frame types that the error type can occur within.

The Inject Within list box provide a list of SAS/SATA/SMP frame types that can be associated with the error type. The user must know enough about the protocol to select the correct frame type for the error that they are trying to induce.

FLOW CONTROL: The Repeat Count represents the number of times, in addition to the initial time, that the error should be induced. The total number of times that the error will occur is equal to ‘Repeat Count+1’. The Normal I/Os (after error) count indicates the number of times that normal I/Os will occur after the error has been induced before the Triggered Event is considered complete. Until the current Triggered Event is complete the program can't continue with the next trigger in the list. This handles the situation where the firmware needs to succeed for ‘x’ number of I/Os after a trigger. For RAID testing, this option is highly effective in verifying different error paths.

The Cycle Triggers checkbox allows a user to specify if the trigger-event list associated with the device should be continually re-executed or not. If not checked, the list is only executed once (in displayed order). When checked, the list will be continually cycled thru (in displayed order). Since this checkbox applies to all the triggers in a list it can only be changed (checked or unchecked ) when the first trigger in the list is selected. If any other trigger is selected (highlighted), the current state remains visible but not editable (grayed out).

ERROR TYPES: A display of some of the possible Error Types is provided in the example window 1028 depicted in FIG. 27.

The standard set of Error Types available are can be summarized as follows:

Non-Good Status—allows any of the standard STATUS values to be returned in the Response Frame. When this option is selected a new window appears and allows the user to select the Status to be returned from a list. The user can select the Sense Key from a list. In addition, there is the option to manually enter values for the ASC & ASCQ. There are two possible Check Conditions in the list—Current vs. Deferred (note: Current is the ‘standard’ method of reporting Check Conditions). The difference between the two is that the ‘Deferred’ Check Condition is reported for an I/O but not the current I/O. This can occur in real physical HDDs when an I/O is reported as successful, since the data was successfully transferred to the HDD's cache, but when the drive physcially attempted to access the media an error occurred and must be reported to the Host. This is also a method used by certain HDD firmware to report S.M.A.R.T.Errors. (see screen shots)

Non-Good Response—allows any of the standard RESPONSE values to be returned in the Response Frame. When this option is selected a new window appears and allows the user to select the RESPONSE to be returned from a list. (see screen shots)

Drop Frame—allows a particular Frame type to be ‘dropped’ from the response stream.

CRC Error—allows a particular Frame type to have a CRC error that the HAB should NACK.

Data Overrun—allows a particular Frame type to have a data overrun error.

Data Underrun—allows a particular Frame type to have a data underrun error.

Frame Len Overrun—allows a particular Frame type to have additional bytes of data.

Frame Len Underrun—allows a particular Frame type to have fewer bytes than required for the Frame type.

Invalid Frame Type—changes the Frame Type value to be changed to an invalid value.

Wrong Hashed Src—changes the Hashed Source address value to be corrupted.

Wrong Hashed Dest—changes the Hashed Destination address value to be corrupted.

Invalid Queue Tag—changes the Queue Tag to an invalid value.

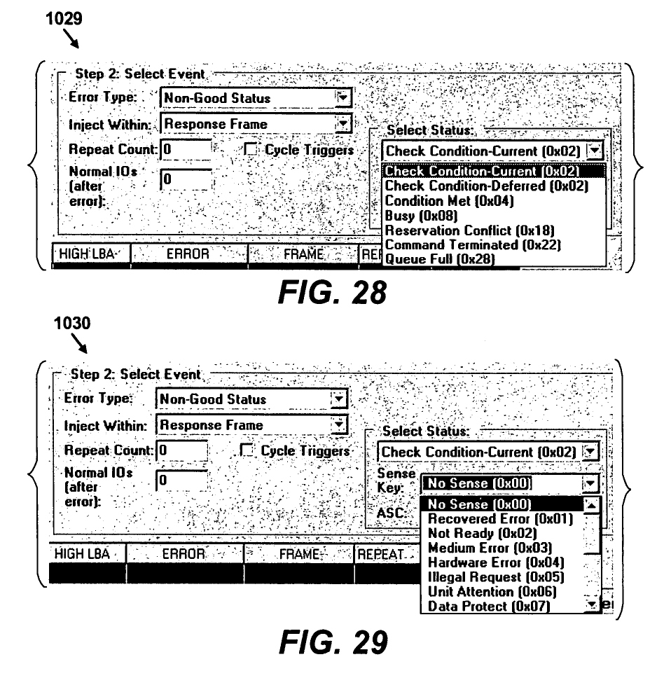

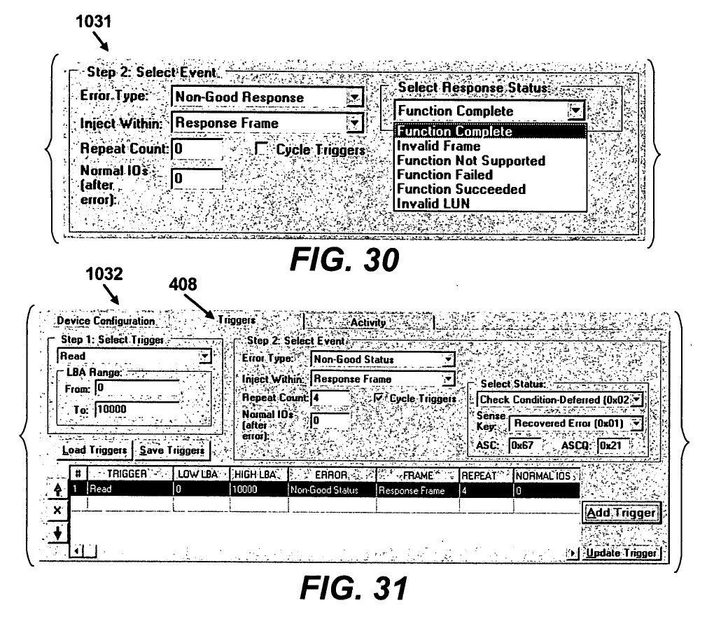

FIG. 28 illustrates a screen shot of a graphical user interface event selection window 1029 in with a preferred embodiment. Window 1029 illustrates an example of a “Non-Good Status” error type. FIG. 29 illustrates a screen shot of a graphical user interface event selection window 1030 in accordance with a preferred embodiment. Window 1030 illustrates the use of a “Sense Key”. FIG. 30 illustrates a screen shot of a graphical user interface window 1031 with a view of a possible response value, in accordance with a preferred embodiment.

FIG. 31 illustrates a screen shot of a graphical user window 1032 and an interface trigger tab 408, in accordance with a preferred embodiment. When a user hits the Add Trigger button, the program validates the information in the Select Trigger and the Select Event window prior to creating the Trigger. If an invalid combination of values have been choosen, a message box will appear. It informs the user of the issue that has been found, no Trigger will be created. Only if all the information is valid will a Trigger be created. The information is then added to the Event List window (holds up to 30 triggers per device). The Event List window only displays the triggers assigned to the highlighted device. Selecting a different device forces the Event List to be refreshed with the new device's Triggered Event data. The following features can be provided via tab 408 depicted in FIG. 31:
MOVE UP: This button will move the currently highlighted Trigger up one row in the Event List window.
MOVE DOWN: This button will move the currently highlighted Trigger down one row in the Event List window.
DELETE: This button will delete the currently highlighted Trigger shown in the Event List window. Note: there is no ‘confirm delete’, undo or restore function if this button was hit by accident.
ADD TRIGGER: This button will add the information from Step 1 and Step 2 windows to the Event List window.
UPDATE TRIGGER: This button will update the currently selected Trigger in the Event List window with the data from Step 1 and Step 2 windows. Note: there is no ‘confirm update’, undo or restore function if this button was hit by accident.
LOAD TRIGGERS: This button allows the user to load an Event List from a previously saved file. The user can only load the Event List for a single device.
SAVE TRIGGERS: This button will allow the user to save an Event List to a file. As usual, the user has the ability to select the directory and to provide a unique name for better file identification.

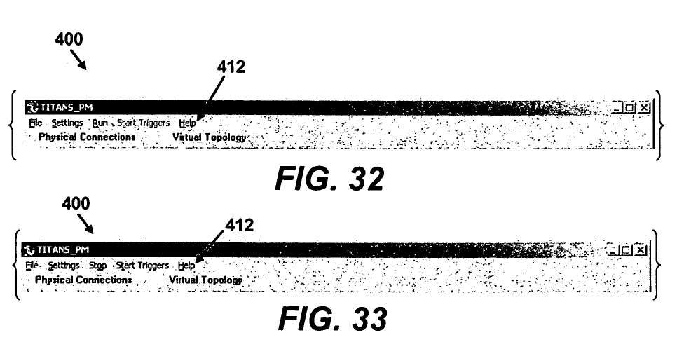

FIG. 32 illustrates a screen shot of a graphical user interface stopped menu 412, in accordance with a preferred embodiment. After creating the devices and their associated Trigger/Events, the user still needs to hit the Run option, from the Menu Bar, in order for the targets to become active (see Stopped Menu). Activating the Run option does not automatically activate the Triggers. ‘Start Triggers’ is a separate option and allows the user to select the best time for the Triggers to become active.

FIG. 33 illustrates a screen shot of a graphical user interface running menu 412, in accordance with a preferred embodiment. After the user hits, Run, the menu bar changes to a Running configuration. The ‘File’ option is disabled, the ‘Start Triggers’ option is enabled, and ‘Run’ has been changed to ‘Stop’.

Activating the Triggers is as simple as clicking on Start Triggers. All Triggers were loaded when the Run button was pressed so it is just a matter of having the program execute them. This means that although it may be possible to create more triggers after the Run button has been hit they will not get executed when triggers are started. Once the user selects the Start Triggers option, the option changes to Stop Triggers. In order to stop the current set of Triggers from executing, the user can simply hit the Stop Triggers button. If the triggers are loaded and are actively running then whenever an I/O that meets the Trigger criteria is encountered, the target device produces the Event response.

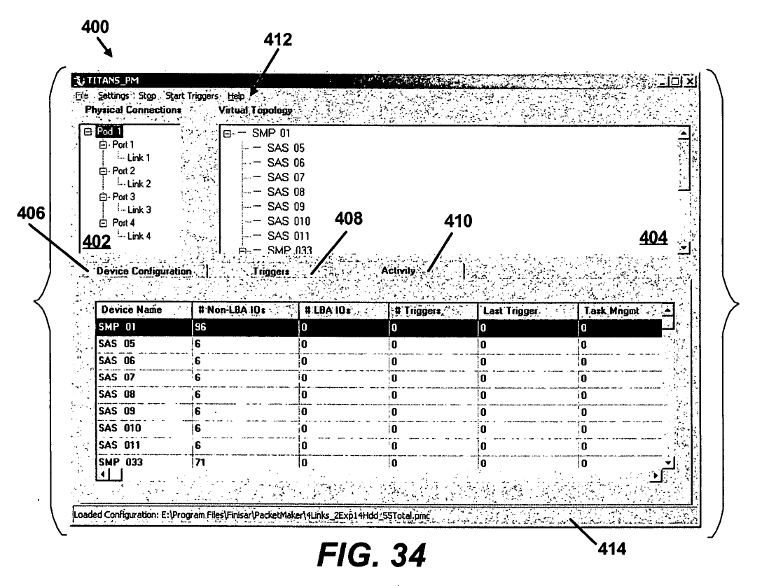

FIG. 34 illustrates a screen shot of a graphical user interface activity tab 410, in accordance with a preferred embodiment. Once a user Starts the program it run automatically, responding to Host requests and injecting errors (if triggers are enabled). This is the only feedback available to the user that the program is running since it issues no I/Os of its own. The Activity Tab shows a summary of all the activity for all virtual devices. The Activity display is updated approximately every 30 seconds. The update frequency is not adjustable.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A data-processing method, comprising:
providing a graphical user interface that generates a simulation of at least one target device based on at least one particular user input to said graphical user interface;
automatically generating said simulation of said at least one target device based on said at least one particular user input to said graphically user interface; and
compiling a topology of said at least one target device based on said simulation of said at least one target device, wherein said topology is utilized for testing of said at least one device.

2. The method of claim 1, further comprising utilizing said simulation of said at least one target device to modify said at least one target device on a per-device basis.

3. The method of claim 1 further comprising:
compiling a script of errors for injection into said at least one target device for testing of said at least one target device based on said simulation of said at least one target device.

4. The method of claim 1 wherein said at least one target device comprises an SAS device.

5. The method of claim 1 wherein said at least one target device comprises an SMP device.

6. The method of claim 1 wherein said at least one target device comprises an SATA device.

7. A system, comprising:
a data-processing apparatus;
a module executed by said data-processing apparatus, said module and said data-processing apparatus being operable in combination with one another to:
provide a graphical user interface that generates a simulation of at least one target device based on at least one particular user input to said graphical user interface;
automatically generate said simulation of said at least one target device based on said at least one particular user input to said graphically user interface; and
compile a topology of said at least one target device based on said simulation of said at least one target device, wherein said topology is utilized for testing of said at least one device.

8. The system of claim 1 wherein said data-processing apparatus and said module are further operable in combination with one another to utilize said simulation of said at least one target device to modify said at least one target device on a per-device basis.

9. The system of claim 1 wherein said data-processing apparatus and said module are further operable in combination with one another to compile a script of errors for injection into said at least one target device for testing of said at least one target device based on said simulation of said at least one target device.

10. The system of claim 1 wherein said at least one target device comprises an SAS device.

11. The system of claim 1 wherein said at least one target device comprises an SMP device.

12. The system of claim 1 wherein said at least one target device comprises an SATA device.

13. The system of claim 1 wherein said at least one target device comprises at least one of the following: an SAS device, an SMP device, or an SATA device.

14. A program product residing in a computer, comprising:
instruction means residing in a computer for providing a graphical user interface that generates a simulation of at least one target device based on at least one particular user input to said graphical user interface;
instruction means residing in a computer for automatically generating said simulation of said at least one target device based on said at least one particular user input to said graphically user interface; and
instruction means residing in a computer for compiling a topology of said at least one target device based on said simulation of said at least one target device, wherein said topology is utilized for testing of said at least one device.

15. The program product of claim 14 further comprising instruction means residing in a computer for utilizing said simulation of said at least one target device to modify said at least one target device on a per-device basis.

16. The program product of claim 14 further comprising instruction means residing in a computer for compiling a script of errors for injection into said at least one target device for testing of said at least one target device based on said simulation of said at least one target device.

17. The program product of claim 14 wherein said at least one target device comprises an SAS device.

18. The program product of claim 14 wherein said at least one target device comprises an SMP device.

19. The program product of claim 14 wherein said at least one target device comprises an SATA device.

20. The program product of claim 14 wherein each of said instruction media further comprises signal bearing media.
